(19) United States
(12) Patent Application Publication
(10) Pub. No.: US 2009/0273456 A1
(43) Pub. Date: Nov. 5, 2009

(54) Freeway safety device

(76) Inventor: Andre Albertini, Poway, CA (US)

Correspondence Address: RUTH EURE, 4795 EDISON AVENUE, BOULDER, CO, 80301, US

(21) Appl. No.: 12/386,358

(22) Filed: Apr. 16, 2009

Related U.S. Application Data
(60) Provisional application No. 61/124,405, filed on Apr. 16, 2008.

(51) Int. Cl. B60Q 1/00; G01S 3/80

(52) U.S. Cl. 340/435; 367/129

(57) ABSTRACT

The present invention provides a freeway safety device which will audibly and visibly alert the driver when a vehicle enters the “blindspot” of the vehicle being driven. The present invention provides an ultrasonic detector which permits location of a detected object by the use of an array of ultrasonic transducers which are sequentially activated to transmit a laterally shifting ultrasonic energy along the array.

### CLAIM OF PRIORITY

This patent application claims priority from U.S. Provisional patent application Ser. No. 61/124,405, filed Apr. 16, 2008, entitled “Freeway Safety Device” of common inventorship herewith.

### FIELD OF THE INVENTION

The present invention relates to the field of automotive accessories, and more particularly to the field of automotive positioning sensors.

### BACKGROUND OF THE INVENTION

The prior art has put forth several collision avoidance systems.

U.S. Pat. No. 5,307,136 to Saneyoshi is directed to a distance detection system for vehicles comprising an image camera system which photographs an object in proximity to an automobile.

U.S. Pat. No. 6,246,961 to Sasaki, et al is directed to a collision alarm method and apparatus for vehicles utilizing an image processing means.

U.S. Pat. No. 6,317,691 to Narayan et al is directed to a collision avoidance system utilizing machine vision tail light tracking.

### SUMMARY OF THE INVENTION

It is an object of the present invention to provide a freeway safety device which will audibly and visibly alert the driver when a vehicle enters the “blindspot” of the vehicle being driven.

An object of the invention is therefore to provide an ultrasonic detector which permits location of a detected object by the use of an array of ultrasonic transducers which are sequentially activated to transmit a laterally shifting ultrasonic energy along the array.

An ultrasonic detector of the invention comprises first and second ultrasonic transmitting transducers arranged in a laterally spaced apart relationship for transmitting an ultrasonic energy of identical directivity pattern from each transmitting transducer, and an ultrasonic receiving transducer located between the transmitting transducers. The receiving transducer has a directivity pattern which partially overlaps the directivity patterns of the transmitting transducers to define laterally spaced apart first and second object detecting regions for receiving an echo returning from an object located therein. Further included are a transmitter circuit for sequentially activating the first and second transmitting transducers with a burst of ultrasonic pulses to transmit a pulsed ultrasonic energy from each transmitting transducer and laterally shift the point of transmission to the other transmitting transducer and a receiver circuit coupled to the receiving transducer for allowing it to receive the echo during the interval between successive beam transmissions. The outputs of the transmitter and receiver circuits are used for generating a display signal representing the lateral position of the object.

### BRIEF DESCRIPTION OF THE DRAWINGS

FIG. 1 shows the location of the sensor of the present invention mounted on a vehicle.

FIG. 2 depicts the signal of the present invention emitted from a vehicle.

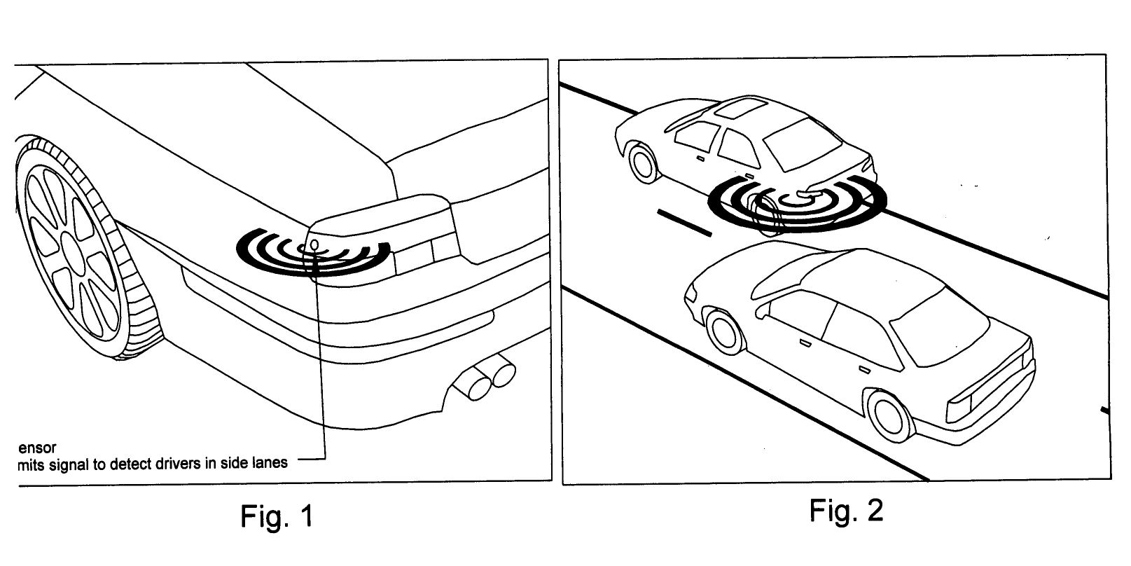

### DETAILED DESCRIPTION OF THE INVENTION

If an alien were to land on earth, the first thing he would notice about the “green planet” is the amount of cars there are on the streets. He would see that they come in all shapes and sizes, colors and are of many different brands. He would attempt to count the cars, but would get lost quickly because no brain can comprehend a number so large. In 1900 there were only 4,192 passenger cars built in the US (the only country to be manufacturing cars). There were no buses or trucks. By 1985 there were 109 million cars in existence. Today, with dozens of countries participating in the creation of automobiles, that number is six times larger. As the population explodes and the number of both commercial and recreational vehicles on America's roads and highways increasing—combined with an exponential increase in interstate travel—accidents between automobiles and trucks on our highways and freeways are rising exponentially. With the substantial increase of drivers and the escalating speed limits on roads and highways in the United States, lane changing accidents have proven to be an increasingly costly hazard for drivers, passengers, and pedestrians alike. Each year there are over 200,000 lane-changing and merging traffic accidents, with over 200 of them resulting in fatalities. According to National Highway Traffic Safety Administration (NHTSA) data for North America, nearly 830,000 vehicles will be damaged or destroyed in blind-spot related lane change accidents during 2007. Vehicle structure and visibility constraints are two factors that create blind spots and cause lane change accidents. Driver vision can be restricted by vehicle architecture, mirror image resolution, the driver's field of vision, and the driver's personal mobility, thereby creating blind spots. A driver's cognitive condition and focus issues are also contributing factors. Almost every driver has experienced a near collision when changing lanes. This invention, hereinafter referred to as the Freeway Safety Device can serve as a ‘lane change assistant,’ combating the constraints of vehicle structure and driver visibility and helping drivers to avoid accidents.

The Freeway Safety Device is manufactured by establishments in the Automotive Parts and Accessories industry. The Freeway Safety Device is, as the name implies, a safety device that consists of two ultrasonic detectors and sensors, lights and a buzzer. The Freeway Safety Device would provide nearly 180-degree field of view within the sensor range, allowing for unprecedented detection of a vehicle in the driver's blind spot. The Freeway Safety Device would be installed on the sides of a vehicle and wired in series with the turn signal lights power supply wires. Whenever the turn signal lever is activated to indicate the vehicle will be moving to the left or right, power is applied to the corresponding sensor and the Freeway Safety Device will work automatically to detect vehicles located to the sides and rear sides of the car, areas referred to as blind spots. If a vehicle is detected, a light on both sides of the dashboard will be blinking and visually alerting the driver that it is unsafe to make a lane change as well as the buzzer in the passenger compartment would be sounded, audibly alerting the driver that it is unsafe to make a lane change. The Freeway Safety Device would provide an effective solution to the dangerous problem of blind spots and minimize the potential for accidents resulting from maneuvering a vehicle while relying on a mirror that has inherent blind spot characteristics.

An ultrasonic detector for roadway vehicles useful in the present invention comprises an array of electroacoustic transducers mounted on the rear of the vehicle. The transducers are sequentially driven by a transmitter circuit to transmit a pulsed, laterally shifting ultrasonic energy toward an object located behind the vehicle in one of plural regions defined by partially overlapped directivity patterns of adjacent transducers. A receiver circuit is coupled to the transducer array to receive echos returning from the object during the interval between successive beam transmissions. A logic circuit detects the lateral position of and the distance to the object for giving relevant indications on a display unit, the audible tone being variable depending on object distance. An audible warning device is optional.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An ultrasonic alarm system for detecting at least one object located with respect to a moving vehicle, comprising:
a first array of ultrasonic transmitting transducers for emitting ultrasonic energies in respective directivity patterns;
a second array of ultrasonic receiving transducers disposed alternatively with said ultrasonic transmitting transducers for receiving ultrasonic echoes reflected from any objects located in laterally overlapping detecting regions defined in said directivity patterns;
first means for sequentially energizing said ultrasonic transmitting transducers to emit the ultrasonic energies successively in said directivity patterns;
second means for sequentially receiving echo signals indicative of said ultrasonic echoes from said ultrasonic receiving transducers;
third means for generating first signals representative of sequential operations of said ultrasonic transmitting transducers;
fourth means for generating second signals of varying durations indicative of different distance ranges in each of said laterally overlapping detecting regions;
display means comprising a matrix of light-emitting elements; and
display control means responsive to said echo signals and said first signals for energizing rows of said light-emitting elements to indicate any objects in said laterally overlapping detecting regions.

2. An ultrasonic alarm system according to claim 1, including an audible alarm generator responsive to said energization signals for generating an audible warning having a variable tone dependent on the position of the objects in said distance ranges.

3. An ultrasonic distance detector for detecting an object moving with respect thereto, comprising:
first and second ultrasonic transmitting transducers arranged in a laterally spaced apart relationship for transmitting ultrasonic energies of identical directivity pattern from each transmitting transducer;
an ultrasonic receiving transducer located between said transmitting transducers and having a directivity pattern which partially overlaps the directivity patterns of said transmitting transducers to define laterally spaced apart first and second object detecting regions for receiving an ultrasonic echo returning from an object located therein;
a transmitter circuit for sequentially activating said first and second transmitting transducers with a burst of ultrasonic pulses to transmit pulsed ultrasonic energy from each transmitting transducer and laterally shift the point of transmission to the other transmitting transducer;
a receiver circuit, coupled to said receiving transducer, for allowing it to receive said echo during an interval between successive energy transmissions from said first and second transmitting transducers;
actuation signal generator means for generating an actuation signal indicative of energization of one of said first and second ultrasonic transmitting transducers as sequentially activated by said transmitter circuit;
display means including a first display area for displaying a distance up to an object in said first object detecting region and a second display area for displaying a distance up to an object in said second object detecting region, said display means including a plurality of light-emitting elements arranged in a two-dimensional pattern of horizontal rows indicative of positions of the objects in said first and second object detecting regions and vertical columns comprising said first and second display areas, respectively, for representing the distances to the objects in said first and second object detecting regions; and
display control means for deriving the distance to the object from a time interval which runs from the time when the ultrasonic energy is transmitted from one of said first and second ultrasonic transmitting transducers by said transmitter circuit to the time when the ultrasonic echo is received by said receiver circuit, and for effecting a display of the derived distance on one of said first and second display area which corresponds to said actuation signal from said actuation signal generator means;
said ultrasonic distance detector including reference signal generator means for generating first and second reference signals representative of first and second distance ranges, respectively, in the direction of emission of the ultrasonic energies in timed relation to the emission of the ultrasonic energies from said first and second ultrasonic transmitting transducers, said display control means including means for comparing a signal from said receiver circuit indicative of reception of the ultrasonic echo with said first and second reference signals from said reference signal generator means to determine whether the object is located in said first or second distance range, and means for energizing those light-emitting elements which correspond to the determined distance range, if any, and to the object detecting region indicated by the actuation signal generator means; and
said ultrasonic distance detector including means for varying the reference signal corresponding to the determined distance range, if any, in order to increase the determined distance range and for restoring said reference signal representative of the original distance range when no object is detected in said distance range.
